(19) United States
(12) Patent Application Publication
(10) Pub. No.: US 2023/0179446 A1
(43) Pub. Date: Jun. 8, 2023

(54) RADIO COMMUNICATION DEVICE

(71) Applicant: Mitsubishi Electric Corporation, Tokyo (JP)

(72) Inventors: Shunsuke UEHASHI, Tokyo (JP); Hiroshi NISHIMOTO, Tokyo (JP); Koji TOMITSUKA, Tokyo (JP)

(73) Assignee: Mitsubishi Electric Corporation, Tokyo (JP)

(21) Appl. No.: 18/164,757

(22) Filed: Feb. 6, 2023

Related U.S. Application Data
(63) Continuation of application No. PCT/JP2020/035224, filed on Sep. 17, 2020.

(51) Int. Cl. H04L 25/02

(52) U.S. Cl. CPC H04L 25/021; H04L 25/0222

(57) ABSTRACT

A radio communication device that receives signals by using a plurality of reception antennas in a radio communication system employing multi-station simultaneous transmission includes: processing circuitry that estimates channel information on the basis of training symbol sequences, which are different depending on the base-station antennas, included in received signals, and outputs a channel information estimation result; performs a channel matrix extending process of extending dimension of a channel matrix on the basis of the channel information estimation result and a coding rule of the received signals, and extending array's degree of freedom; generates an interference suppression weight by using the channel matrix resulting from the channel matrix extending process; and extends dimension of a received signal vector by using a result of observation over symbol duration time for a plurality of symbols, and multiplies the received signal vector resulting from the extension of dimension by the interference suppression weight.

### CROSS-REFERENCE TO RELATED APPLICATION

This application is a continuation application of International Application PCT/JP2020/035224, filed on Sep. 17, 2020, and designating the U.S., the entire content of which are incorporated herein by reference.

### BACKGROUND OF THE INVENTION

### 1. Field of the Invention

The present disclosure relates to a radio communication device, a control circuit, a storage medium, and a signal processing method in a radio communication system in which a plurality of base stations perform radio communication with mobile stations by using identical frequencies.

### 2. Description of the Related Art

### BACKGROUND

Transmission diversity technologies have been used as technologies for reducing influence of fading and the like in radio signal transmission. Especially, space-frequency block coding (SFBC), space-time block coding (STBC), and differential space-time block coding (DSTBC) capable of obtaining the diversity effect by transmitting signals according to a specific rule by using a plurality of transmission antennas are used in various systems for such a reason as processing at a receiving station being simple. For example, in DSTBC of dual-antenna transmission, a transmitting station include two symbols in one block, and performs differential coding using data of two blocks. A receiving station can achieve the diversity effect only by differential decoding of received data of two blocks, and can demodulate the data.

In addition, a multi-station simultaneous transmission technology is present as a technology for expanding a cell range in a radio communication system to form a cell (hereinafter referred to as a large cell to be distinguished from the original cell). While the cell size is limited when a single base station is used, the multi-station simultaneous transmission technology is a method of virtually forming a large cell by handling identical signals with frequencies identical with each other at a plurality of base stations. Hereinafter, a large cell that is virtually formed by a plurality of base stations through multi-station simultaneous transmission will be referred to as a zone. In terms of efficient use of frequency, it is desirable to use the same radio frequencies in different zones. In this case, because the identical radio frequencies are used, there is a problem of interference in a boundary area between adjacent cells or zones, that is, an area called a cell end or a zone end.

As a measure against interference, there is a method of including a plurality of antennas, which are also called an array antenna, in a mobile station, and controlling the directionality by multiplying received signals received by the antennas by weight coefficients, that is, weights and combining the weighted signals, so as to reduce or prevent interference signals. The number of antennas in an array antenna is also called the array's degree of freedom. When the number of antennas included is equal to or larger than a sum of the number of desired signals to be extracted and the number of interference signals to be reduced or prevented, appropriate directionality control, signal separation, interference signal reduction or prevention, and the like can be performed. Typically, however, the number of antennas that can be mounted on a mobile station is limited by installation spaces, constraints on equipment, and the like. Furthermore, a plurality of desired signals and a plurality of interference signals may arrive and a number of signals exceeding the array's degree of freedom may be received at a mobile station. In particular, when a transmission diversity method like DSTBC is used at a transmitting station, the transmitting station needs two or more antennas, and a large number of signals exceeding the number of antennas mounted on a mobile station are likely to arrive at a zone boundary of a multi-station simultaneous transmission system. Under such circumstances, it is difficult for the mobile station to appropriately reduce or prevent interference signal, and a problem how to measure against interference in a zone boundary area rises.

To address such a problem, Non Patent Literature 1 teaches a technology of extending a channel matrix to two dimensions in the frequency direction and the spatial direction by using the coding rule of SFBC as a measure against interference between cells for Long Term Evolution (LTE)-Advanced downlink, to improve the array's degree of freedom to twice the number of antennas included in the mobile station and thus improve the interference reduction or prevention effect.

### CITATION LIST

### Non Patent Literature

Non Patent Literature 1: Yusuke Ohwatari, Nobuhiko Miki, Yuta Sagae, and Yukihiko Okumura, “Investigation on Interference Rejection Combining Receiver for Space-Frequency Block Code Transmit Diversity in LTE-Advanced Downlink,” IEEE Transactions on Vehicular Technology, Vol. 63, No. 1, January 2014, pp. 191-203.

### Technical Problem

The technology described in Non Patent Literature 1, however, teaches no method for application to a modulation method based on differential coding and differential decoding in the time domain like DSTBC. Furthermore, because the technology described in Non Patent Literature 1 is not based on a multi-station simultaneous transmission system, it is difficult to address the problem specific to a multi-station simultaneous transmission system. For example, in a multi-station simultaneous transmission system, the same signals with each other are transmitted from base stations within a zone. When a propagation delay difference is caused by different propagation distances between the mobile station and the individual base stations or when the accuracy of time synchronization between base stations is not sufficient, the mobile station receives the signals from the individual base stations with a certain time difference, which is problematic in that inter-symbol interference may be caused. In addition, signals from a plurality of base stations forming a plurality of zones may arrive at a zone boundary in a multi-station simultaneous transmission system, and even if the array's degree of freedom of a receiving station is increased as in Non Patent Literature 1, there is a problem in that the characteristics degrade when more signals than the increased array's degree of freedom arrive.

The present disclosure has been made in view of the above, and an object thereof is to provide a radio communication device capable of improving the effect of reducing or preventing interference in arrival of a plurality of signals.

### SUMMARY OF THE INVENTION

To solve the above problem and achieve an object, the present disclosure is directed to a radio communication device that receives signals by using a plurality of reception antennas in a radio communication system employing multi-station simultaneous transmission in which a plurality of base stations transmit signals including identical data symbol sequences with one another at identical frequencies with one another from base-station antennas of the base stations. The radio communication device includes: processing circuitry to estimate channel information on a channel between each of the base-station antennas and each of the reception antennas on the basis of training symbol sequences included in received signals, and output a channel information estimation result, the training symbol sequences being different depending on the base-station antennas; to perform a channel matrix extending process of extending dimension of a channel matrix on the basis of the channel information estimation result and a coding rule of the received signals, and extending array's degree of freedom of the radio communication device; to generate an interference suppression weight for reducing or preventing an interference signal by using the channel matrix resulting from the channel matrix extending process; and to extend dimension of a received signal vector by using a result of observation over symbol duration time for a plurality of symbols, and multiply the received signal vector resulting from the extension of dimension by the interference suppression weight to reduce or prevent the interference signal, wherein the base stations transmit the signals obtained by modulation in a differential space-time block coding method, the processing circuitry performs the channel matrix extending process on the basis of a coding rule of the differential space-time block coding, the processing circuitry performs observation over the symbol duration time for the plurality of symbols in units of blocks in the differential space-time block coding, and the received signals each have a radio frame format including a training symbol sequence that differs depending on the base-station antennas, and the differential space-time block coding of the data symbol sequence is performed by using any one symbol in the training symbol sequences as a start symbol

### BRIEF DESCRIPTION OF THE DRAWINGS

FIG. 1 is a first diagram illustrating an example of a configuration of a radio communication system according to a first embodiment.

FIG. 2 is a first diagram illustrating an example of formats of radio frames transmitted from base stations according to the first embodiment.

FIG. 3 is a block diagram illustrating an example of a configuration of a radio communication device included in a mobile station according to the first embodiment.

FIG. 4 is a flowchart illustrating operations of the radio communication device according to the first embodiment.

FIG. 5 is a second diagram illustrating an example of a configuration of the radio communication system according to the first embodiment.

FIG. 6 is a second diagram illustrating an example of formats of radio frames transmitted from base stations according to the first embodiment.

FIG. 7 is a diagram illustrating an example of a configuration of a radio communication system according to a second embodiment.

FIG. 8 is a block diagram illustrating an example of a configuration of a radio communication device included in a mobile station according to a second embodiment.

FIG. 9 is a flowchart illustrating operations of the radio communication device according to the second embodiment.

FIG. 10 is a diagram illustrating an example of a configuration of processing circuitry 90 when the processing circuitry included in the radio communication device 100 according to the first embodiment and the radio communication device 100a according to the second embodiment are each implemented by a processor and a memory.

FIG. 11 is a diagram illustrating an example of processing circuitry 93 when the processing circuitry included in the radio communication device 100 according to the first embodiment and the radio communication device 100a according to the second embodiment is implemented by dedicated hardware.

### DETAILED DESCRIPTION OF THE PREFERRED EMBODIMENTS

A radio communication device, a control circuit, a storage medium, and a signal processing method according to certain embodiments of the present disclosure will be described in detail below with reference to the drawings.

### First Embodiment

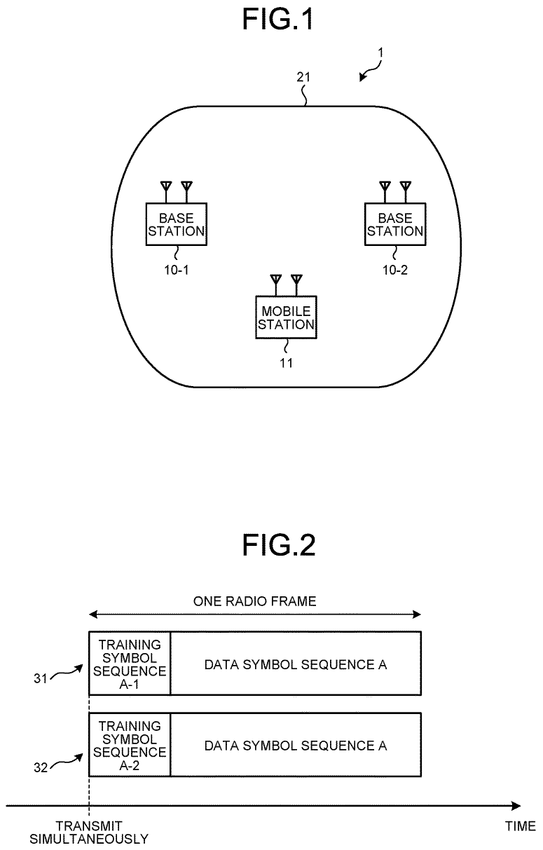

FIG. 1 is a first diagram illustrating an example of a configuration of a radio communication system 1 according to a first embodiment. The radio communication system 1 includes base stations 10-1 and 10-2, and a mobile station 11. The radio communication system 1 is a system using multi-station simultaneous transmission by which a plurality of base stations 10-1 and 10-2 transmit signals including the same data symbol sequence to each other at identical frequencies from base-station antennas thereof. In the description below, the base stations 10-1 and 10-2 will be simply referred to as base stations 10 when the base stations 10-1 and 10-2 need not be distinguished from each other. While a case where the radio communication system 1 includes two base stations 10 and one mobile station 11 is illustrated in FIG. 1 for simplicity, this is an example, and the number of base stations 10 and the number of mobile stations 11 included in the radio communication system 1 are not limited to those in the example of FIG. 1. The radio communication system 1 may include three or more base stations 10, and may include two or more mobile stations 11. In FIG. 1, the base stations 10-1 and 10-2 are base stations 10 that form the same zone 21 as each other in a multi-station simultaneous transmission system. The base stations 10 that together form the same zone transmit radio frames including the same data symbol sequence as each other except for training symbol sequences. Although base-station antennas are provided outside the base stations 10 in FIG. 1, assume that the base-station antennas are also included in the base stations 10. Similarly, although a reception antenna is provided outside the mobile station 11, assume that the reception antenna is also included in the mobile station 11. The same applies to subsequent embodiments.

The base stations 10-1 and 10-2 have functions of transmission devices that transmit signals including training symbol sequences different from each other by using the identical frequencies to each other. Training symbol sequences are symbol sequences expressed by complexes and known in transmission and reception, and are different depending on base stations 10 or depending on base-station antennas.

FIG. 2 is a first diagram illustrating an example of formats of radio frames 31 and 32 transmitted from the base stations 10-1 and 10-2, respectively, according to the first embodiment. The radio frame 31 to be transmitted from the base station 10-1 includes a training symbol sequence A-1 and a data symbol sequence A. The radio frame 32 to be transmitted from the base station 10-2 includes a training symbol sequence A-2 and the data symbol sequence A. The radio frames 31 and 32 are transmitted simultaneously in synchronization between the base stations 10-1 and 10-2. Note that, in a case where the base station 10 includes two base-station antennas as illustrated in FIG. 1 and transmit radio frames including different training symbol sequences to each other depending on the base-station antennas, a training symbol sequence in a radio frame to be transmitted from one base-station antenna of the base station 10-1 will be referred to as a training symbol sequence A-la, and a training symbol sequence in a radio frame to be transmitted from the other base-station antenna of the base station 10-1 will be referred to as a training symbol sequence A-lb, for example. Similarly, a training symbol sequence in a radio frame to be transmitted from one base-station antenna of the base station 10-2 will be referred to as a training symbol sequence A-2a, and a training symbol sequence in a radio frame to be transmitted from the other base-station antenna of the base station 10-2 will be referred to as a training symbol sequence A-2b.

Regarding these training symbol sequences, the base station 10 from which each of the training symbol sequences has been transmitted can be identified by the mobile station 11. The mobile station 11 can therefore know which base station 10 the mobile station 11 is communicating with. In addition, the data symbol sequences illustrated in FIG. 2 are DSTBC modulated sequences. For differential coding such as DSTBC, a start symbol is necessary. Thus, for a start symbol, any one symbol, such as the last symbol, in a training symbol sequence is used. As a result of using training symbol sequences that are different to each other depending on base stations 10 or depending on base-station antennas as described above, the mobile station 11 can identify the base station 10 from which each radio frame was transmitted. In addition, each base station 10 can make signals with the same data symbol sequence on different signal constellations by performing differential coding of DSTBC on any of different training symbol sequences as a start symbol. This is equivalent to reducing correlation between two signals, the value of which is originally “1”. As a result, the mobile station 11 can handle signals including the same data symbol sequences as each other transmitted from the base stations 10-1 and 10-2 in the same zone as signals of different waveforms. The mobile station 11 uses this characteristic to reduce or prevent interference in the first and second embodiments.

Note that, in a manner similar to this process, the following document teaches a method of applying a phase offset between transmission antennas of different base stations as a method for reducing correlation between DSTBC signals including the identical data symbol sequences with one another transmitted at the same time from a plurality of base stations.

Satoshi Sasaki, Hiroyasu Sano, Shinji Masuda, and Atsushi Okamura, “Phase Offset Method between Transmit Antennas for Avoiding Beat Interference in Differential Space-Time Block Coding”, 2017, Society Conference of The Institute of Electronics, Information and Communication Engineers

A phase offset can be applied to a DSTBC coded signal as presented in this document, but this approach additionally requires design of a phase offset value for each base station 10. In the present embodiment, a method of achieving interference reduction or prevention by a simpler manner will be explained.

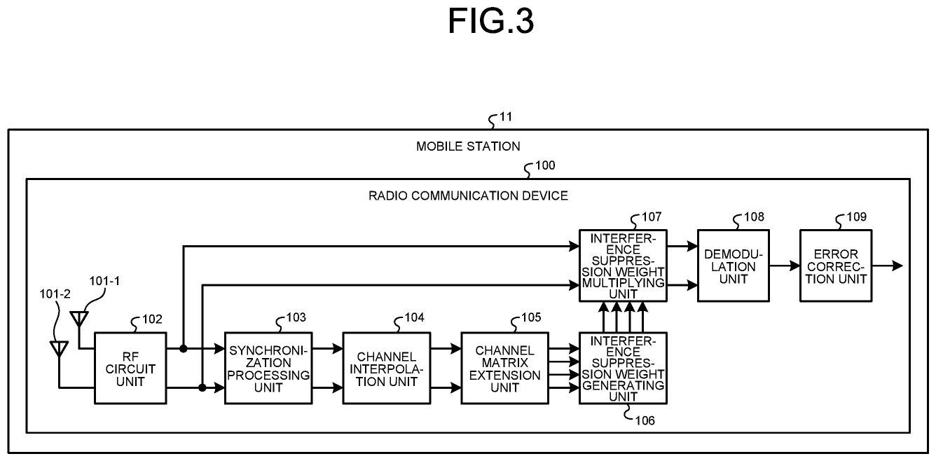

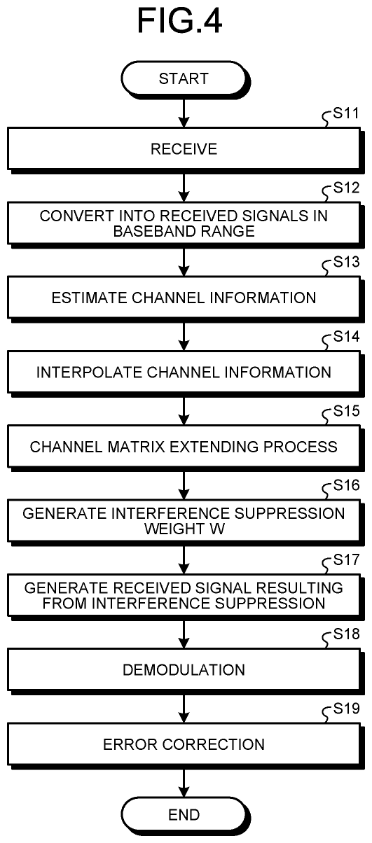

FIG. 3 is a block diagram illustrating an example of a configuration of a radio communication device 100 included in the mobile station 11 according to the first embodiment. The radio communication device 100 is a reception device that receives DSTBC coded transmission signals transmitted from the base stations 10 by using a plurality of reception antennas 101 in the radio communication system 1 in which multi-station simultaneous transmission is performed using identical frequencies. The radio communication device 100 includes reception antennas 101-1 and 101-2, a radio frequency (RF) circuit unit 102, a synchronization processing unit 103, a channel interpolation unit 104, a channel matrix extension unit 105, an interference suppression weight generating unit 106, an interference suppression weight multiplying unit 107, a demodulation unit 108, and an error correction unit 109. FIG. 4 is a flowchart illustrating operations of the radio communication device 100 according to the first embodiment.

The reception antennas 101-1 and 101-2 receive radio signals from the base stations 10 via propagation channels (step S11). In the description below, the reception antennas 101-1 and 101-2 will be simply referred to as reception antennas 101 when the reception antennas 101-1 and 101-2 need not be distinguished from each other. While the radio communication device 100 that includes two reception antennas 101 is illustrated for simplicity in FIG. 3, this is an example and the reception antennas 101 are not limited thereto. The radio communication device 100 may include three or more reception antennas 101. The reception antennas 101 output received signals, which are received radio signals, to the RF circuit unit 102.

The RF circuit unit 102 down-converts the received signals obtained from the reception antennas 101 for conversion into received signals in a baseband range (step S12). The RF circuit unit 102 may include an analog/digital (A/D) converter, and generates received signals in the baseband range on the basis of various frequency conversion technologies, and outputs the resulting signals to the synchronization processing unit 103 and the interference suppression weight multiplying unit 107.

The synchronization processing unit 103 estimates training symbol sequences included in the received signals received by the reception antennas 101, detects radio frames by using the training symbol sequences, and estimates channel information on each channel between each of the base-station antennas and each of the reception antennas 101 (step S13). Specifically, the synchronization processing unit 103 estimates channel information on each channel between each of the base-station antennas and each of the reception antennas 101 on the basis of training symbol sequences, which are different depending on the base-station antennas and included in the received signals, and outputs the result of channel information estimation. As described above, when a particular training symbol sequence is assigned to each base-station antenna, the mobile station 11 can identify the base stations 10 by using the training symbol sequences and estimate channel information on each base-station antenna. Note that channel information includes a complex amplitude value of a radio transmission channel, that is, a channel response, and an arrival delay amount. Typically, the channel response is time-varying fading that varies owing to fading of radio wave propagation. In addition, the arrival delay amount varies owing to a physical transmission distance between the base station 10 and the mobile station 11, relative positions thereof, radio wave propagation, and the like. Typically, the arrival delay amount is larger as the distance is longer.

The synchronization processing unit 103 estimates frequency deviation of a received signal by using the training symbol sequence by various automatic frequency control (AFC) technologies, and performs correction. The synchronization processing unit 103 also performs a downsampling process in which a symbol timing is estimated by using a cross-correlation timing of the training symbol sequence or the like, and a symbol determination point is extracted by using the estimated value from an oversampled received signal. The synchronization processing unit 103 outputs the channel information on the channel between each of the base-station antennas and each of the reception antennas 101, which is estimated by using the training symbol sequences, to the channel interpolation unit 104.

The channel interpolation unit 104 interpolates the channel information in the time domain for the purpose of avoiding reduction in the interference reduction or preventing effect as a result of time-varying channel information and loss of orthogonality of an interference suppression weight W used subsequently, which are due to time-varying fading caused by movement of the mobile station 11 while the mobile station 11 is receiving radio frames (step S14). The method for interpolation of channel information may be, in a case where a plurality of training symbol sequences are present in a radio frame, linear interpolation of linearly interpolating channel information estimated from a plurality of pieces of channel information data based on the training symbol sequences, or may be quadratic or higher interpolation such as Lagrange interpolation or spline interpolation. In addition, the channel interpolation unit 104 may obtain feedback of the determination result from the subsequent demodulation unit 108, and sequentially perform a determination-oriented channel estimation process using a determination signal generated from the determination result to estimate channel information. Furthermore, when only one training symbol sequence is included in a radio frame as illustrated in FIG. 2, the channel interpolation unit 104 may interpolate channel information in a frame to be demodulated by using channel information obtained from a training symbol sequence in a radio frame received next.

Note that, in a case where channel variation is negligible in a radio frame, the channel interpolation unit 104 may omit the interpolation process. When moving speed information of the mobile station 11 can be obtained and the fading variation speed can be predicted to some extent, the channel interpolation unit 104 may switch between performing and not performing the interpolation process depending on the predicted fading variation speed. Alternatively, a suitable interpolation method depending on the fading variation speed may be selected. As described above, the channel interpolation unit 104 can change the interpolation method.

The channel matrix extension unit 105 performs a channel matrix extending process of extending the channel matrix size in two dimensions of the time direction and the spatial direction, that is, the dimension of the channel matrix by utilizing the structure of a DSTBC coded and modulated symbol sequence, which is a data symbol sequence included in a radio frame transmitted from a base station 10 (step S15). Specifically, the channel matrix extension unit 105 performs the channel matrix extending process of extending the dimension of the channel matrix on the basis of the result of estimation of channel information and a coding rule of a received signal, and extending the array's degree of freedom of the radio communication device 100. The channel matrix extension unit 105 outputs the channel matrix resulting from extension of the dimension in the channel matrix extending process, to the interference suppression weight generating unit 106. In the present embodiment, the channel matrix extension unit 105 can improve the interference reduction or prevention effect by improving the array's degree of freedom of the radio communication device 100 through the channel matrix extending process. The channel matrix extending process performed by the channel matrix extension unit 105 will be described in detail with reference to a specific example of a case where signals transmitted from two base stations 10-1 and 10-2 each including dual antennas are received by two reception antennas 101 mounted on the mobile station 11 as illustrated in FIG. 1.

A two-dimensional received signal vector constituted by signals y₁(t) and y₂(t) received at the t-th symbol by the respective reception antennas 101 of the mobile station 11 is expressed as in formula (1).

Formula 1:

y(t)=[y₁(t),y₂(t)]^{T} (1)

A channel matrix of 2×2 constituted by channel information h_{1,ij} between the antennas of the base station 10-1 and the mobile station 11 is represented by H₁, and a channel matrix of 2×2 constituted by channel information h_{2,ij} between the antennas of the base station 10-2 and the mobile station 11 is represented by H₂. In addition, two-dimensional transmission signal vectors x₁(t) and x₂(t) transmitted from the base-station antennas are expressed as in formula (2) and formula (3), respectively.

Formula 2:

x₁(t)=[x_{1,1}(t),x_{1,2}(t)]^{T} (2)

Formula 3:

x₂(t)=[x_{2,1}(t),x_{2,2}(t)]^{T} (3)

In this case, formula (1) can be expressed as in formula (4). Note that H₁ and H₂ are expressed as in formula (5) and formula (6), respectively.

$$\begin{matrix}Formula 4 & \\ y ( t ) = {H}_{1} {x}_{1} ( t ) + {H}_{2} {x}_{2} ( t ) & ( 4 )\end{matrix}$$

$$\begin{matrix}Formula 5 & \\ {H}_{1} = [ \begin{matrix}{h}_{1 , 00} & {h}_{1 , 01} \\ {h}_{1 , 10} & {h}_{1 , 11}\end{matrix} ] & ( 5 )\end{matrix}$$

$$\begin{matrix}Formula 6 & \\ {H}_{2} = [ \begin{matrix}{h}_{2 , 00} & {h}_{2 , 01} \\ {h}_{2 , 10} & {h}_{2 , 11}\end{matrix} ] & ( 6 )\end{matrix}$$

As a result of putting these formulas together, expressions as in formula (7) and formula (8) are obtained.

$$\begin{matrix}Formula 7 & \\ y ( t ) = [ {H}_{1} {H}_{2} ] [ \begin{matrix}{x}_{1} ( t ) \\ {x}_{2} ( t )\end{matrix} ] & ( 7 )\end{matrix}$$

$$\begin{matrix}Formula 8 & \\ [ \begin{matrix}{y}_{1} ( t ) \\ {y}_{2} ( t )\end{matrix} ] = [ \begin{matrix}{h}_{1 , 00} & {h}_{1 , 01} & {h}_{2 , 00} & {h}_{2 , 01} \\ {h}_{1 , 10} & {h}_{1 , 11} & {h}_{2 , 10} & {h}_{2 , 11}\end{matrix} ] [ \begin{matrix}{x}_{1 , 1} ( t ) \\ {x}_{1 , 2} ( t ) \\ {x}_{2 , 1} ( t ) \\ {x}_{2 , 2} ( t )\end{matrix} ] & ( 8 )\end{matrix}$$

In formula (8), because the number of reception antennas 101 of the mobile station 11 is two, the array's degree of freedom is two. When four signals arrive from two base stations 10 each including dual antennas, more signals than the array's degree of freedom arrive at the mobile station 11, thus the interference reduction or prevention performance thereof degrades. In other words, formula (8) is an underdetermined problem of estimating four unknowns, that is, transmission signals from two equations, which makes it difficult to obtain accurate solutions. The channel matrix extending process in the time direction and the spatial direction is applied here. For DSTBC of dual-antenna transmissions, the base station 10 swaps transmission signals of dual antennas for symbol duration time for two symbols, performs complex conjugate, sign inversion, and the like, and performs differential block coding. The elements of a t-th symbol DSTBC coded transmission signal vector x₁(t) and a (t+1)-th symbol DSTBC coded transmission signal vector x₁(t+1) satisfy the relations in formula (9) and formula (10).

Formula 9:

x_{1,1}(t)=x_{1,2}(t+1) (9)

Formula 10:

x_{1,2}(t)=−x_{1,1}(t+1) (10)

The channel matrix extension unit 105 performs observation in accordance with the DSTBC rules over symbol duration time for a plurality of symbols corresponding to one block unit, that is, symbol duration time for two symbols because one block corresponds to two symbols here, that is, over the t-th symbol and the (t+1)-th symbol. Of the received signal vectors obtained during the symbol duration time for two symbols, a received signal vector y(t) is expressed by formula (1), and a received signal vector y(t+1) is expressed by formula (11).

Formula 11:

y(t+1)=[y₁(t+1),y₂(t+1)]^{T} (11)

Formula (1) and formula (11) are combined, and a dimension-extended received signal vector y′(t,t+1) is defined as in formula (12).

Formula 12:

y′(t,t+1)=[y₁(t),−y*₁(t+1),y₂(t),−y*₂(t+1)]^{T} (12)

As a result, formula (8) can be converted as in formula (13). Note that H′₁ and H′₂ are expressed as in formula (14) and formula (15), respectively.

$$\begin{matrix}Formula 13 & \\ [ \begin{matrix}{y}_{1} ( t ) \\ - {y}_{1}^{*} ( t + 1 ) \\ {y}_{2} ( t ) \\ - {y}_{2}^{*} ( t + 1 )\end{matrix} ] = [ \begin{matrix}{h}_{1 , 00} & {h}_{1 , 01} & {h}_{2 , 00} & {h}_{2 , 01} \\ - {h}_{1 , 01}^{*} & {h}_{1 , 00}^{*} & - {h}_{2 , 01}^{*} & {h}_{2 , 00}^{*} \\ {h}_{1 , 10} & {h}_{1 , 11} & {h}_{2 , 10} & {h}_{2 , 11} \\ - {h}_{1 , 11}^{*} & {h}_{1 , 10}^{*} & - {h}_{2 , 11}^{*} & {h}_{2 , 10}^{*}\end{matrix} ] [ \begin{matrix}{x}_{1 , 1} ( t ) \\ {x}_{1 , 2} ( t ) \\ {x}_{2 , 1} ( t ) \\ {x}_{2 , 2} ( t )\end{matrix} ] & ( 13 )\end{matrix}$$

$$\begin{matrix}Formula 14 & \\ {H}_{1}^{′} = [ \begin{matrix}{h}_{1 , 00} & {h}_{1 , 01} \\ - {h}_{1 , 01}^{*} & {h}_{1 , 00}^{*} \\ {h}_{1 , 10} & {h}_{1 , 11} \\ - {h}_{1 , 11}^{*} & {h}_{1 , 10}^{*}\end{matrix} ] & ( 14 )\end{matrix}$$

$$\begin{matrix}Formula 15 & \\ {H}_{2}^{′} = [ \begin{matrix}{h}_{2 , 00} & {h}_{2 , 01} \\ - {h}_{2 , 01}^{*} & {h}_{2 , 00}^{*} \\ {h}_{2 , 10} & {h}_{2 , 11} \\ - {h}_{2 , 11}^{*} & {h}_{2 , 10}^{*}\end{matrix} ] & ( 15 )\end{matrix}$$

As a result of putting these formulas together, an expression as in formula (16) is obtained.

$$\begin{matrix}Formula 16 & \\ {y}^{′} ( t , t + 1 ) = [ {H}_{1}^{′} {H}_{2}^{′} ] [ \begin{matrix}{x}_{1} ( t ) \\ {x}_{2} ( t )\end{matrix} ] & ( 16 )\end{matrix}$$

As described above, the channel matrix extension unit 105 focuses on the structure of the DSTBC coded and modulated symbol sequence transmitted from a base station 10, virtually extends a reception antenna vector to four dimensions by extending the size of a channel matrix, that is, the dimension of the channel matrix, extends the channel matrix to a 4×4 matrix, and can thus improve the array's degree of freedom from two to four. This is equivalent to converting formula (8), which is an underdetermined problem, into formula (13), which is a decision problem with the same number of unknowns and the number of equations. As a result, the channel matrix extension unit 105 can accurately separate signals transmitted from the individual base stations 10, and thus improve the interference reduction or prevention effect.

In multi-station simultaneous transmission, signals from the base stations 10 are transmitted at the same timing like the radio frames 31 and 32 illustrated in FIG. 2. In practice, however, some signals are received with certain time differences at the mobile station 11 because of propagation delay differences caused by differences in distances between the mobile station 11 and each of the base stations 10, low accuracy of time synchronization between base stations 10, etc. In such a case, the signals cause inter-symbol interference, which degrades the reception characteristics of the mobile station 11. In addition, when signals with high correlation therebetween are transmitted from a plurality of base stations 10, the signals with opposite phases may be combined at a receiving point, which periodically lowers the signal power and degrades the reception performance.

For DSTBC modulation of two radio frames 31 and 32, which are originally the same data symbol sequences as described above, however, the mobile station 11, handles the radio frames 31 and 32 as different signals by defining any one symbol among the training symbol sequences, which are different depending on the base-station antennas, as a start symbol of DSTBC differential coding to make the signals on different signal constellations, thereby lowering the correlation between the signals. As a result, the mobile station 11 can reduce or prevent the inter-symbol interference by separating the signals by a determined system obtained through extension of a channel matrix. At the same time, the mobile station 11 can prevent periodic reduction in power caused by combination of opposite phases. Therefore, it is possible to reduce or prevent degradation in the reception performance.

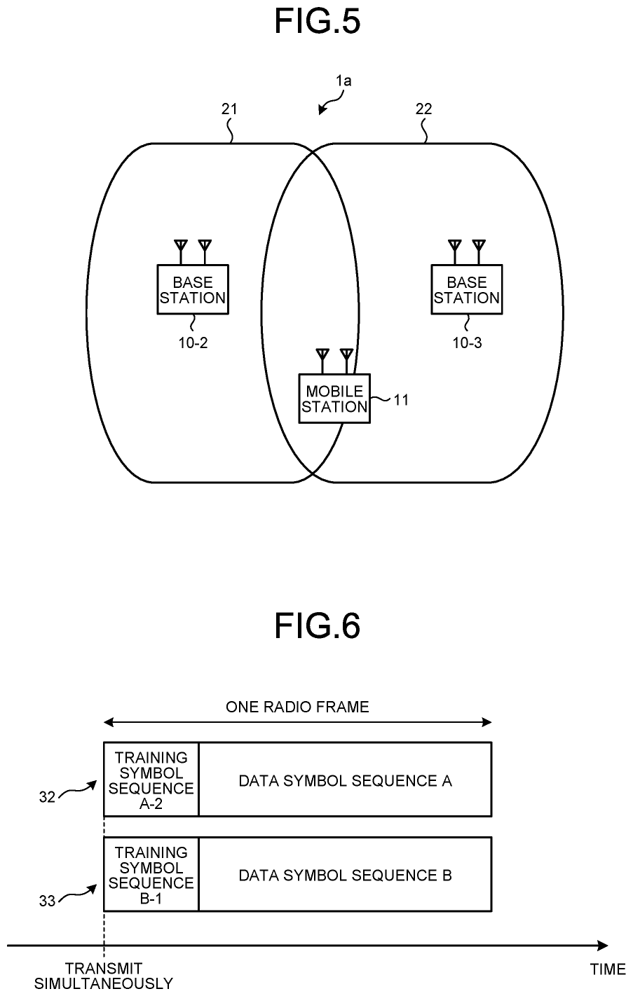

Another pattern of the radio communication system 1 will now be described. FIG. 5 is a second diagram illustrating an example of a configuration of a radio communication system 1a according to the first embodiment. The radio communication system 1a includes base stations 10-2 and 10-3, and the mobile station 11. In the radio communication system 1a, the base station 10-2 forms a zone 21, and the base station 10-3 forms a zone 22. The mobile station 11 moves across a zone boundary between the zones 21 and 22.

FIG. 6 is a second diagram illustrating an example of formats of radio frames 32 and 33 transmitted from the base stations 10-2 and 10-3 according to the first embodiment. The radio frame 32 transmitted from the base station 10-2 includes a training symbol sequence A-2 and the data symbol sequence A. The radio frame 33 transmitted from the base station 10-3 includes a training symbol sequence B-1 and a data symbol sequence B. The radio frames 32 and 33 are transmitted simultaneously in synchronization between the base stations 10-2 and 10-3. Note that, in a case where the base station 10 includes two base-station antennas as illustrated in FIG. 5 and transmit radio frames including different training symbol sequences depending on the base-station antennas, a training symbol sequence in a radio frame transmitted from one base-station antenna of the base station 10-2 will be referred to as a training symbol sequence A-2a, and a training symbol sequence in a radio frame transmitted from the other base-station antenna of the base station 10-2 will be referred to as a training symbol sequence A-2b, for example. Similarly, a training symbol sequence in a radio frame transmitted from one base-station antenna of the base station 10-3 will be referred to as a training symbol sequence B-1a, and a training symbol sequence in a radio frame transmitted from the other base-station antenna of the base station 10-3 will be referred to as a training symbol sequence B-1b.

In the radio communication system 1a illustrated in FIG. 5, radio frames 32 and 33 including training symbol sequences different from each other and data symbol sequences different from each other are transmitted from the base stations 10. The mobile station 11 receives a radio signal combining these radio frames 32 and 33.

In such an environment as well, the channel matrix extension unit 105 of the radio communication device 100 included in the mobile station 11 can generate weights for separating the signals as a decision problem by extending the channel matrix assuming DSTBC modulation as in formula (16). In summary, when signals from a plurality of base stations 10 within a zone arrive and also when signals from base stations 10 forming respective zones arrive at a zone boundary, the radio communication device 100 of the mobile station 11 can cause the number of arriving signals to fall within the array's degree of freedom through the same channel matrix extending process, and reduce or prevent interference. This means that, in the channel matrix extension unit 105, inter-symbol interference within a zone can be reduced or prevented by selecting the channels of the stations 10-1 and 10-2 as the channel matrices to be extended, and inter-zone interference at a zone boundary can be reduced or prevented by selecting the channels of the base stations 10-2 and 10-3 as the channel matrices to be extended. The channel matrix extension unit 105 can separate any interference by selecting a channel for which the channel matrix is to be extended. As described above, the channel matrix extension unit 105 selects either generating an interference suppression weight W for reducing or preventing inter-symbol interference occurring within a zone with regarding signals including the same data symbol sequence transmitted from a plurality of base stations 10 forming a single zone as different signals from each other and performing the channel matrix extending process, or generating an interference suppression weight W for reducing or preventing inter-zone interference by performing the channel matrix extending process on the channel matrices of a plurality of base stations 10 forming different zones.

The description refers back to the radio communication device 100. The interference suppression weight generating unit 106 generates an interference suppression weight W by using the channel matrix resulting from dimension extension obtained from the channel matrix extension unit 105 (step S16). Specifically, the interference suppression weight generating unit 106 generates an interference suppression weight W for reducing or preventing an interference signal by using the channel matrix resulting from the channel matrix extending process. The interference suppression weight generating unit 106 outputs the generated interference suppression weight W to the interference suppression weight multiplying unit 107. In the interference suppression weight generating unit 106, various algorithms are applicable to a calculation algorithm for generating a weight matrix of the interference suppression weight W to achieve interference reduction or prevention. Examples of the calculation algorithm include a minimum mean square error (MMSE) standard algorithm as in formula (17), and a whitening algorithm as in formula (18).

Formula 17:

W=H′₁^{H}(H′₁H′₁^{H}+H′₂H′₂^{H}+σ²I)⁻¹ (17)

Formula 18:

W=(H′₂H′₂^{H}+σ²I)^{-1/2} (18)

In formula (17) and formula (18), σ² represents thermal noise power estimated at the mobile station 11 on the receiver end, and I represents an identity matrix. As a result of including an addition term of σ²I in calculation of an inverse matrix or a square root of an inverse matrix, reduction or prevention in view of both interference and thermal noise can be achieved. In addition, the addition term of G²I also serves for avoiding instability of matrix operation. Note that the calculation algorithm is not limited to the examples presented above, and the interference suppression weight generating unit 106 may apply other calculation algorithms. In addition, formula (17) and formula (18) express demodulation of a signal received via H′₁, and as for a signal received via H′₂, the interference suppression weight generating unit 106 may replace H′₁ with H′₂ before calculating the weight matrix. As described above, the mobile station 11 can determine which of the base stations 10 is to be a desired station and which of the base stations 10 is an interfering station. For the determination method, the mobile station 11 may use power information in the channel information, or may make the determination on the basis of distance information when physical distances from the individual base stations 10 are known.

In addition, when signals from the same zone are separated and demodulated as illustrated in FIG. 1, the signals include the same data symbol sequence. Thus, the mobile station 11 can lower the error rate by the diversity effect when the mobile station 11 performs demodulation with regarding the individual base stations 10 as desired stations and adds the demodulation results or by selecting a demodulation result.

The interference suppression weight multiplying unit 107 multiplies each antenna reception signal obtained from the RF circuit unit 102 by the interference suppression weight W generated by the interference suppression weight generating unit 106 to generate a received signal resulting from interference reduction or prevention (step S17). The interference suppression weight multiplying unit 107 multiplies each antenna reception signal by the interference suppression weight W resulting from channel matrix extension generated by the interference suppression weight generating unit 106. Thus, the interference suppression weight multiplying unit 107 performs observation for time corresponding to the block length of DSTBC such as y′(t,t+1) in formula (16), and multiplies each of antenna reception signals, which result from extension of the dimension of received signal vectors of signals received during symbol duration time for a plurality of symbols, by the interference suppression weight W. In this manner, the interference suppression weight multiplying unit 107 extends the dimension of the received signal vectors by using the results of observation over the symbol duration time for a plurality of symbols, and multiplies the received signal vectors resulting from extension of the dimension by the interference suppression weight W to reduce or prevent the interference signals. The interference suppression weight multiplying unit 107 outputs the generated received signal resulting from interference reduction or prevention to the demodulation unit 108.

The demodulation unit 108 performs DSTBC demodulation on the received signals resulting from interference reduction or prevention obtained from the interference suppression weight multiplying unit 107 (step S18). Specifically, the demodulation unit 108 performs a demodulation process such as a soft decision process, a hard decision process, and a deinterleaving process necessary for error correction to be performed by the error correction unit 109. The demodulation unit 108 outputs the demodulation result to the error correction unit 109.

The error correction unit 109 performs error correction using an error correction code on the basis of the demodulation result obtained from the demodulation unit 108 (step S19). The error correction unit 109 outputs the decoding result obtained by the error correction.

As described above, in the radio communication system 1, a plurality of base stations 10 transmit signals modulated by DSTBC coding, that is, a differential space-time block coding method. In the mobile station 11, the channel matrix extension unit 105 of the radio communication device 100 performs the channel matrix extending process on the basis of the coding rules of DSTBC coding. The interference suppression weight multiplying unit 107 performs observation for symbol duration time for a plurality of symbols in units of blocks of DSTBC coding. In the radio communication device 100, a received signal has a radio frame format including a training symbol sequence that differs depending on the base-station antenna, and DSTBC coding is performed on a data symbol sequence by using any one symbol included in the training symbol sequence as a start symbol.

As described above, according to the present embodiment, when signals from a plurality of base stations 10 that transmit the same data symbol sequence within a zone in multi-station simultaneous transmission arrive with time differences causing inter-symbol interference, or when signals from a plurality of base stations 10 forming different zones are received around a zone boundary, the radio communication device 100 improves the array's degree of freedom by extending the dimension of a channel matrix to two dimensions of the time direction and the spatial direction on the basis of the coding rules of DSTBC modulation. As a result, the radio communication device 100 achieves appropriate interference reduction or prevention, can improve the interference reduction or prevention effect when a plurality of signals arrive, and reduce or prevent degradation of demodulation performance. In addition, the radio communication device 100 can reduce or prevent the two interferences described above by the same configuration by selecting the channel used for the channel extension process, which also produces an effect of reducing the circuit size.

### Second Embodiment

In the first embodiment, a case in which the mobile station 11 improves the array's degree of freedom by performing the channel matrix extending process and thus reduces or prevents interference within a zone or at a zone boundary has been described. In a second embodiment, a case where signals arrive from a plurality of base stations 10 forming a plurality of zones, and the mobile station 11 receives, at a zone boundary, more signals than the array's degree of freedom extended through the channel matrix extending process in the first embodiment, for example, will be described.

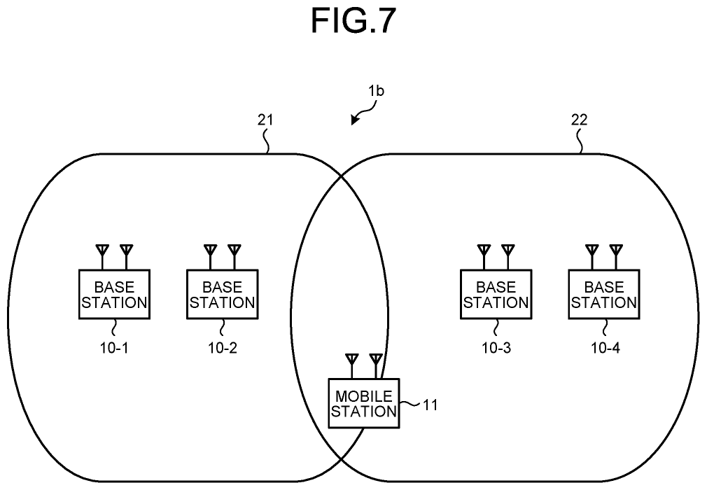

FIG. 7 is a diagram illustrating an example of a configuration of a radio communication system 1b according to the second embodiment. The radio communication system 1b includes base stations 10-1 to 10-4, and the mobile station 11. In the description below, the base stations 10-1 to 10-4 will be simply referred to as base stations 10 when the base stations 10-1 to 10-4 need not be distinguished from each other. While the radio communication system 1b includes two base stations 10 in each zone and one mobile station 11 in FIG. 7 for simplicity, this is an example, and the number of base stations 10 and the number of mobile stations 11 included in the radio communication system 1b are not limited to those in the example of FIG. 7. The radio communication system 1b may include three or more base stations 10, and may include two or more mobile stations 11 in each zone. In FIG. 7, the base stations 10-1 and 10-2 are base stations 10 that together form the same zone 21 in a multi-station simultaneous transmission system, and the base stations 10-3 and 10-4 are base stations 10 that together form the same zone 22 in the multi-station simultaneous transmission system.

In FIG. 7, because signals from four base stations 10 each including two base-station antennas arrive, the mobile station 11 including two reception antennas 101 receives eight signals while the array's degree of freedom is two. In such an environment, formula (16) obtained by extension of the channel matrix is an underdetermined problem with eight unknowns with respect to four equations like formula (19).

$$\begin{matrix}Formula 19 & \\ {y}^{′} ( t , t + 1 ) = [ {H}_{1}^{′} {H}_{2}^{′} {G}_{1}^{′} {G}_{2}^{′} ] [ \begin{matrix}{x}_{1} ( t ) \\ {x}_{2} ( t ) \\ {x}_{3} ( t ) \\ {x}_{4} ( t )\end{matrix} ] & ( 19 )\end{matrix}$$

In formula (19), H′₁ represents a channel matrix resulting from channel extension corresponding to the base station 10-1, and x₁(t) represents a two-dimensional transmission signal vector transmitted from the base station 10-1. In addition, H′₂ represents a channel matrix resulting from channel extension corresponding to the base station 10-2, and x₂(t) represents a two-dimensional transmission signal vector transmitted from the base station 10-2. In addition, G′₁ represents a channel matrix resulting from channel extension corresponding to the base station 10-3, and x₃(t) represents a two-dimensional transmission signal vector transmitted from the base station 10-3. In addition, G′₂ represents a channel matrix resulting from channel extension corresponding to the base station 10-4, and x₄(t) represents a two-dimensional transmission signal vector transmitted from the base station 10-4. A radio communication device 100a according to the second embodiment, which will be described later, reduces or prevents interference signals with high accuracy even when more signals than the array's degree of freedom resulting from channel extension arrive from two different zones formed by a plurality of base stations 10 as described above. In other words, the radio communication device 100a can solve formula (14) and formula (15) as decision problems by performing a channel matrix conversion and channel combining process on the channel matrices of formula (14) and formula (15).

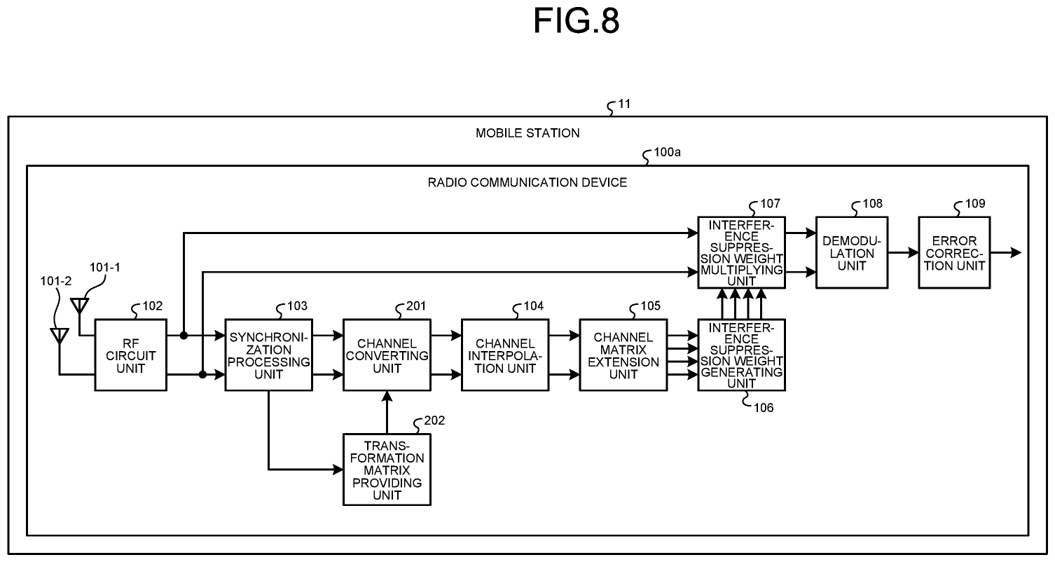

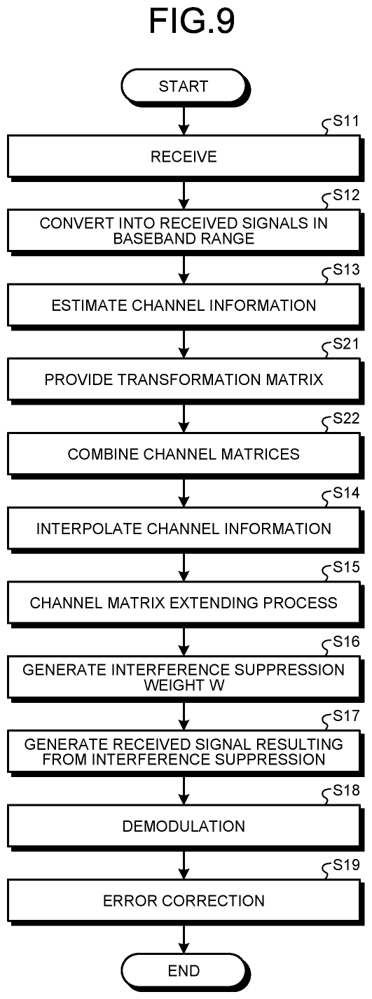

FIG. 8 is a block diagram illustrating an example of a configuration of a radio communication device 100a included in the mobile station 11 according to the second embodiment. The radio communication device 100a additionally includes a channel converting unit 201 and a transformation matrix providing unit 202 as compared with the radio communication device 100 of the first embodiment illustrated in FIG. 3. FIG. 9 is a flowchart illustrating operations of the radio communication device 100a according to the second embodiment. In the flowchart illustrated in FIG. 9, the operations from step S11 to step S13 and the operations from step S14 to step S19 are similar to the operations from step S11 to step S19 in the flowchart of the first embodiment illustrated in FIG. 4.

The transformation matrix providing unit 202 provides, to the channel converting unit 201, a transformation matrix for increasing correlation between signals transmitted from a plurality of base stations 10 forming the same zone and combining the channel matrices on the basis of the training symbol sequences of the individual base stations 10 estimated by the synchronization processing unit 103 (step S21). The transformation matrix providing unit 202 may obtain the transformation matrix to be provided by calculation, or read the transformation matrix to be provided, which was calculated in advance and saved in a memory, as necessary.

The channel converting unit 201 multiplies the channel matrix of each base station 10 estimated in the synchronization processing unit 103 by the transformation matrix obtained from the transformation matrix providing unit 202 to increase correlation between signals transmitted from base stations 10 in the same zone, and then combines the channel matrices (step S22). Specifically, the channel converting unit 201 multiplies, by the transformation matrix, the channel matrices between the reception antennas 101 and base station antennas of a plurality of base stations 10 that form a single zone by transmitting the same data symbol sequence, and combines the channel matrices.

The principle of replacement of an underdetermined problem with a decision problem when separating signals transmitted from a plurality of base stations 10 in a plurality of zones by the channel matrix conversion in the radio communication device 100a will be explained.

For example, a transformation matrix A can be expressed as formula (20), and a transformation matrix B can be expressed as formula (21).

Formula 20:

x₂(t)=Ax₁(t) (20)

Formula 21:

x₄(t)=Bx₃(t)— (21)

The transformation matrices A and B are matrices that are present for each combination of training symbol sequences for identifying the individual base stations 10, and that can be calculated from a start symbol of DSTBC included in each of the training symbol sequences. The radio communication device 100a can convert data symbol sequences at different signal points due to difference in start symbols, into data symbol sequences at the same signal points by multiplying transmission signal vectors by the transformation matrices. This is equivalent to increasing correlation between a plurality of signals including the same data symbol sequences with one another obtained by DSTBC modulation using, as a start symbol, any one symbol in training symbol sequences different from one another. Formula (19) can be expressed as formula (22) by the transformation matrices expressed by formula (20) and formula (21).

$$\begin{matrix}Formula 22 & \\ {y}^{′} ( t , t + 1 ) = [ {H}_{1}^{′} + {H}_{2}^{′} A {G}_{1}^{′} + {G}_{2}^{′} B ] [ \begin{matrix}{x}_{1} ( t ) \\ {x}_{3} ( t )\end{matrix} ] & ( 22 )\end{matrix}$$

In this manner, an equation that is an underdetermined problem can be expressed as a determined system. As a result, the radio communication device 100a can increase the effect of reduction or prevention obtained by the interference suppression weight W. In summary, the channel converting unit 201 and the transformation matrix providing unit 202 convert and combine channel matrices H′₁, H′₂, G′₁, and G′₂ obtained from the synchronization processing unit 103 into H′₁+H′₂A and G′₁+G′₂B by using the transformation matrices A and B corresponding to reference signals of the individual base stations 10, and outputs the resulting matrices to the channel interpolation unit 104. While two base stations 10 belong to the zone 21 and two base stations 10 belong to the zone 22 for simplicity in the description, this is an example, and the number of base stations 10 belonging to each zone is not limited thereto. For example, when signals arrive from N base stations 10 forming the zone 21 and M base stations 10 forming the zone 22 and transformation matrices Aₙ and Bₘ corresponding to the individual base station channels are obtained, received signal vectors can be combined as in formula (23).

$$\begin{matrix}Formula 23 & \\ y ( t ) = [ {\sum }_{n = 1}^{N} {H}_{n}^{′} {A}_{n} {\sum }_{m = 1}^{M} {G}_{m}^{′} {B}_{m} ] [ \begin{matrix}{x}_{1} ( t ) \\ {x}_{N + 1} ( t )\end{matrix} ] & ( 23 )\end{matrix}$$

As expressed by formula (23), expression in a determined system is possible regardless of the numbers N and M. After combining the channels as described above, the radio communication device 100a calculates MMSE weights and the like, and applies the MMSE weights to received signals, which enables interference reduction or prevention with high accuracy.

For example, in a method of calculating transformation matrices for combining the channels of the base stations 10-1 and 10-2, a symbol sequence obtained by using a data symbol sequence A as a start symbol of DSTBC modulation from the training symbol sequence A-1 transmitted from the base station 10-1, and a symbol sequence obtained by using the data symbol sequence A as a start symbol of DSTBC modulation from the training symbol sequence A-2 transmitted from the base station 10-2 are used. Thus, transformation matrices are present for each group of base stations forming a single zone or for each group of base-station antennas. The transformation matrix providing unit 202 may save results of calculation of the transformation matrices in advance, read a transformation matrix on the basis of information on the training symbol sequence obtained from the synchronization processing unit 103, that is, information on the base station 10, and provide the transformation matrix to the channel converting unit 201. Alternatively, the transformation matrix providing unit 202 may calculate a transformation matrix as necessary and provide the obtained transformation matrix. Specifically, the transformation matrix providing unit 202 calculates a transformation matrix on the basis of a start symbol of DSTBC coding included in a training symbol sequence that differs depending on the base-station antenna, or stores a transformation matrix calculated on the basis of a start symbol of DSTBC coding included in a training symbol sequence that differs depending on the base-station antenna.

While the radio communication device 100a multiplies a channel matrix resulting from extension by a transformation matrix in the description above, the radio communication device 100a may perform channel matrix extension after applying a transformation matrix to the channel matrix before channel matrix extension in order to reduce the amount of computation. The effects produced by the radio communication device 100a do not change even when the order in which these processes are performed is changed.

As described above, according to the present embodiment, when performing communication with one or more base stations 10 forming a different zone at around a zone boundary in multi-station simultaneous transmission, the radio communication device 100a can accurately reduce or prevent interference even when still more signals than the array's degree of freedom, which has been improved by channel matrix extension in the time direction and the spatial direction, are received. Specifically, the radio communication device 100a can avoid an underdetermined problem and make it deemed to be a decision problem by multiplying channel matrices of the base stations 10 forming the same zone by transformation matrices calculated from a start symbol of DSTBC modulation included in a training symbol sequence and combining the resulting channel matrices. As a result, even when signals from a plurality of base stations 10 arrive at a zone boundary, the radio communication device 100a can separate the signals arriving from the base stations 10 in the respective zones, and maintain accurate demodulation performance.

In addition, in the first and second embodiments, the radio communication devices 100 and 100a can modulate signals in each zone by replacing desired elements and interference elements with each other in the interference suppressing process of separating desired elements from interference elements in the expression of a determined system. The radio communication devices 100 and 100a may perform the aforementioned process in conjunction with a handover method in switching between zones by demodulating each of signals from the respective zones, comparing results of cyclic redundancy check (CRC) thereof, and recognizing a zone with more CRC OKs as a desired zone. Specifically, the radio communication devices 100 and 100a may perform a handover process in switching between zones by demodulating each of signals in a plurality of zones while replacing a signal to be a desired signal and a signal to be an interference signal with each other, and comparing the demodulation results.

A hardware configuration of the radio communication devices 100 and 100a will now be described. In the radio communication devices 100 and 100a, the reception antennas 101 and the RF circuit unit 102 are implemented by receivers. The other components of the radio communication devices 100 and 100a are implemented by processing circuitry. The processing circuitry may be constituted by a processor that executes programs stored in a memory and the memory, or may be dedicated hardware. The processing circuitry is also called a control circuit.

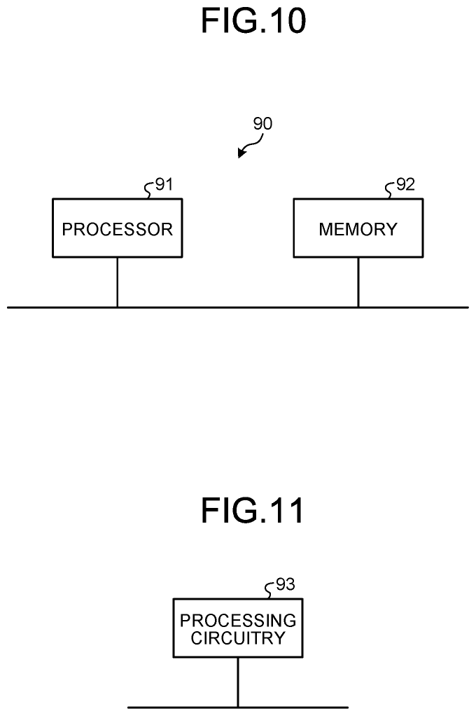

FIG. 10 is a diagram illustrating an example of a configuration of processing circuitry 90 when the processing circuitry included in the radio communication device 100 according to the first embodiment and the radio communication device 100a according to the second embodiment are each implemented by a processor and a memory. The processing circuitry 90 illustrated in FIG. 10 is a control circuit including a processor 91 and a memory 92. When the processing circuitry 90 is constituted by the processor 91 and the memory 92, the functions of the processing circuitry 90 are implemented by software, firmware, or a combination of software and firmware. The software or firmware is described in the form of programs and stored in the memory 92. The processing circuitry 90 implements the functions by reading and executing the programs stored in the memory 92 by the processor 91. Specifically, the processing circuitry 90 includes the memory 92 for storing programs that results in execution of processes of the radio communication devices 100 and 100a. The programs are, in other words, programs causing the radio communication devices 100 and 100a to perform the functions implemented by the processing circuitry 90. The programs may be provided by a storage medium storing the programs, or may be provided by other means such as a communication medium.

Note that the processor 91 is a central processing unit (CPU), a processing device, a computing device, a microprocessor, a microcomputer, a digital signal processor (DSP), or the like, for example. In addition, the memory 92 is a nonvolatile or volatile semiconductor memory such as a random access memory (RAM), a read only memory (ROM), a flash memory, an erasable programmable ROM (EPROM), or an electrically EPROM (EEPROM: registered trademark), a magnetic disk, a flexible disk, an optical disk, a compact disc, a mini disc, a digital versatile disc (DVD) or the like, for example.

FIG. 11 is a diagram illustrating an example of processing circuitry 93 when the processing circuitry included in the radio communication device 100 according to the first embodiment and the radio communication device 100a according to the second embodiment is implemented by dedicated hardware. The processing circuitry 93 illustrated in FIG. 11 is a single circuit, a composite circuit, a programmed processor, a parallel-programmed processor, an application specific integrated circuit (ASIC), a field programmable gate array (FPGA), or a combination thereof, for example. Part of the processing circuitry may be implemented by dedicated hardware, and part thereof may be implemented by software or firmware. As described above, the processing circuitry is capable of implementing the above-described functions by dedicated hardware, software, firmware, or a combination thereof.

The configurations presented in the embodiments above are examples, and can be combined with other known technologies or with each other, or can be partly omitted or modified without departing from the gist.

For example, in radio communication systems 1, 1a, and 1b in which error correction codes are not used, the error correction unit 109 may be omitted from the radio communication devices 100 and 100a. In an environment in which phase noise is so large that it is not negligible, the radio communication devices 100 and 100a may include a phase compensation function at a prior or subsequent stage of the demodulation unit 108 to additionally perform a process of correcting a deviation from an observed reference phase on a filter output or a filter input following the variation of the phase offset of a received signal. The radio communication device 100 and 100a may also include a waveform shaping filter with a fixed coefficient, such as a roll off filter, on the downstream side of the RF circuit unit 102.

A radio communication device according to the present disclosure produces an effect of improving the effect of reducing or preventing interference effect in arrival of a plurality of signals.

What is claimed is:

1. A radio communication device that receives signals by using a plurality of reception antennas in a radio communication system employing multi-station simultaneous transmission in which a plurality of base stations transmit signals including identical data symbol sequences with one another at identical frequencies with one another from base-station antennas of the base stations, the radio communication device comprising:
processing circuitry
to estimate channel information on a channel between each of the base-station antennas and each of the reception antennas on the basis of training symbol sequences included in received signals, and output a channel information estimation result, the training symbol sequences being different depending on the base-station antennas;
to perform a channel matrix extending process of extending dimension of a channel matrix on the basis of the channel information estimation result and a coding rule of the received signals, and extending array's degree of freedom of the radio communication device;
to generate an interference suppression weight for reducing or preventing an interference signal by using the channel matrix resulting from the channel matrix extending process; and
to extend dimension of a received signal vector by using a result of observation over symbol duration time for a plurality of symbols, and multiply the received signal vector resulting from the extension of dimension by the interference suppression weight to reduce or prevent the interference signal, wherein
the base stations transmit the signals obtained by modulation in a differential space-time block coding method,
the processing circuitry performs the channel matrix extending process on the basis of a coding rule of the differential space-time block coding,
the processing circuitry performs observation over the symbol duration time for the plurality of symbols in units of blocks in the differential space-time block coding, and
the received signals each have a radio frame format including a training symbol sequence that differs depending on the base-station antennas, and the differential space-time block coding of the data symbol sequence is performed by using any one symbol in the training symbol sequences as a start symbol.

2. The radio communication device according to claim 1, wherein
the processing circuitry selects either generating the interference suppression weight for reducing or preventing inter-symbol interference occurring within a same zone by regarding the signals including the identical data symbol sequences with one another transmitted from the plurality of base stations forming the same zone as different signals from each other and performing a channel matrix extending process, or generating the interference suppression weight for reducing or preventing inter-zone interference by performing the channel matrix extending process on channel matrices of the plurality of base stations forming different zones from one another.

3. The radio communication device according to claim 1, wherein,
the processing circuitry provides a transformation matrix for increasing correlation between the signals transmitted from the base stations forming a same zone and combining the channel matrices; and
multiplies, by the transformation matrix, channel matrices between the reception antennas and the base-station antennas of the base stations forming the same zone by transmitting identical data symbol sequences with one another, and combines the channel matrices.

4. The radio communication device according to claim 2, wherein,
the processing circuitry provides a transformation matrix for increasing correlation between the signals transmitted from the base stations forming a same zone and combining the channel matrices; and
multiplies, by the transformation matrix, channel matrices between the reception antennas and the base-station antennas of the base stations forming the same zone by transmitting identical data symbol sequences with one another, and combines the channel matrices.

5. The radio communication device according to claim 3, wherein
the processing circuitry calculates the transformation matrix on the basis of a start symbol of differential space-time block coding included in a training symbol sequence that differs depending on the base-station antennas, or stores the transformation matrix calculated on the basis of a start symbol of differential space-time block coding included in a training symbol sequence that differs depending on the base-station antennas.

6. The radio communication device according to claim 4, wherein
the processing circuitry calculates the transformation matrix on the basis of a start symbol of differential space-time block coding included in a training symbol sequence that differs depending on the base-station antennas, or stores the transformation matrix calculated on the basis of a start symbol of differential space-time block coding included in a training symbol sequence that differs depending on the base-station antennas.
